(19) United States
(12) Patent Application Publication
(10) Pub. No.: US 2022/0340704 A1
(43) Pub. Date: Oct. 27, 2022

(54) SPRAY POLYURETHANE ELASTOMERS AND METHODS FOR PRODUCING THE SAME

(71) Applicant: BASF SE, Ludwigshafen Am Rhein (DE)

(72) Inventors: Liying Wang, Wyandotte, MI (US); Brad J. Martin, Wyandotte, MI (US)

(21) Appl. No.: 17/760,787

(22) PCT Filed: Sep. 30, 2020
(86) PCT No.: PCT/US2020/053385

§ 371 Date: Mar. 16, 2022

Related U.S. Application Data
(60) Provisional application No. 62/907,878, filed on Sep. 30, 2019.

(51) Int. Cl. C08G 18/10; C08G 18/32; C08G 18/42

(52) U.S. Cl. CPC C08G 18/10; C08G 18/3206; C08G 18/4202; C08G 18/4238; C08G 2150/50

(57) ABSTRACT

The present disclosure relates to spray polyether and polyester polyurethane elastomeric articles and associated methods of producing such elastomer articles. More specifically, the invention provides spray polyester polyurethane elastomer articles that exhibit excellent tensile and tear strength, superior elongation performance and improved abrasion resistance performance with tunable tensile modulus.

### FIELD OF THE INVENTION

The present application relates generally to spray polyurethane elastomers, methods for producing articles utilizing such spray polyurethane elastomers and resulting articles thereof.

### BACKGROUND OF THE INVENTION

Spray polyurethane elastomers are utilized in many applications including high end products used in automotive and other related fields for purposes such as interior materials, instrument panel skin, and seating skin. Generally, spray polyurethane elastomers are based on two-component polyurethane systems formulated from a polyol resin and an isocyanate or isocyanate-prepolymer. Conventional spray elastomers can be separated into three main categories as spray polyurethane, spray polyurea, and a hybrid system of polyurethane/polyurea derived from the use of polyether polyols, polyamines or a combination. The resin composition usually contains low viscosity polyols and additives such as catalysts, surfactants, chain extenders, cross linkers, fillers, etc. Most polyurethane elastomers usually contain one or more polyols with high OH functionality that create crosslinking for better mechanical properties. When combined with sophisticated finishing tools and techniques, spray technology enables a unique process for designing products with appealing effects including mixed colors, logos, textures. In addition, spray technology also offers attractive luxurious looks and beautiful touches superior to other materials. With the growing need for high tensile and tear strength as well as superior elongation performance and scratch resistance, the development for improved spray polyurethane elastomers having such attributes is in continuous demand for use in a variety of applications. For example, such elastomers may be used as an anti-abrasion or anti-scratch layer on certain articles or as a shoe component, i.e. outsole or protective coating layer for midsole, unit sole or upper. Because of their excellent physical properties, in particular tear and tensile strength, polyester polyurethane elastomers have been used in a multiplicity of applications, including industrial and consumer goods. However, due to their viscosity, reactivity profile and ability-to process characteristics, polyester-based polyurethane elastomers are mostly manufactured by casting. No polyester polyurethane system has been widely studied and processed via spray technology, which can further) enable air injection in order to reduce density to the range of 0.60-0.90 g/cm³ as desired. Spray polyester elastomers can also open the door to many new applications where spray polyether polyurethane and spray polyurea have shown limitations, for instance, products that need to have superior elongation performance and high resistance to organic solvents, chemical, grease, oil, and fuel.

There is also a growing desire to replace coated fabrics (e.g. synthetic leathers) with improved materials. Coated fabrics are textiles/scrims that have a thin coating on one surface. Such textiles serve to provide performance attributes including tensile strength, tensile modulus, and tear resistance. The textiles are usually flexible, and typically retain flexibility after coating. The coating serves as a protective layer for the textile, offering certain level of abrasion resistance while also offering aesthetic features such as color and texture. The coating provides little contribution to tensile strength, tensile modulus, and tear resistance. Coated fabrics are known to have high tensile modulus and, as a result, resistance to creep and permanent deformation while in service. It is desirable in many applications (such as footwear) to resist creep. Polyurethane, on the other hand, can be susceptible to creep and permanent deformation. Accordingly, a novel polyurethane approach is required in order to get an adequate substitute for coated fabric.

With respect to tensile modulus, certain applications may require low tensile modulus, other applications require high tensile modulus. In either cases an excellent strength and elongation is needed. What is needed is the development of spray polyester elastomers with tunable tensile modulus, especially at a lower density of about less than 0.95 g/cm³.

In summary, what is needed are improved spray polyester elastomers having a suitable density (preferably lower density), good resistance to permanent deformation, and tunable modulus.

### SUMMARY OF THE INVENTION

Disclosed herein are novel compositions related to spray polyurethane elastomeric articles and associated methods of producing such elastomer articles. More specifically, provided herein are spray polyester polyurethane elastomer articles that exhibit excellent tensile and tear strength, superior elongation performance and improved abrasion resistance performance with tunable modulus. Compared to spray polyether polyurethane and spray polyurea, the spray polyester polyurethane produced in accordance with the present disclosure provides advantages including superior mechanical properties and unique properties for novel applications where spray polyether polyurethane and spray polyurea have shown limitations, for instance, better elongation performance and scratch resistance, high resistance to organic solvents, chemical, grease, oil, and fuel; as well as high resistance to creep and permanent deformation while in service. Moreover, spray polyester polyurethane elastomers produced in accordance with the present invention show better adhesion to a variety of different surfaces (fabric, plastic, wood, glass and metal) than spray polyether.

In certain embodiments, the spray technology described herein includes the injection of air into the composition in order to reduce the density of the overall composition. In certain embodiments, the density may be reduced as desired, for example, to the range of 0.60-1.20 g/cm3. Using the methods and processes described, resulting articles have superior elongation performance, high resistance to harsh environments and superior resilience to chemicals, friction and the like.

Disclosed herein are novel compositions comprising a spray polyurethane elastomer, including: (a) an isocyanate functional urethane prepolymer derived from monomeric diphenylmethane diisocyanate (MMDI) and a polyester polyol; and (b) an isocyanate-reactive component including a polyol in the amount of about 10-60 to about 90-95 parts by weight of the isocyanate-reactive component, wherein the polyol is a polyester polyol with a hydroxyl number of about 30 to about 200 mg KOH/g.

Also disclosed are methods for forming spray polyurethane elastomers, the methods including reacting an MMDI with a polyester diol to form an isocyanate functional urethane prepolymer, blending at least one polyol to form an isocyanate-reactive component, and mixing the isocyanate prepolymer and the isocyanate-reactive component at about 85 isocyanate index to about 130 isocyanate index to form the polyurethane elastomer. In an embodiment, the polyol is present in an amount of about 10 to about 90 parts by weight of the isocyanate-reactive component, and the polyol comprises a polyester polyol with a hydroxyl number of about 30 to about 200 mg KOH/g.

Other features and advantages of the present invention will be readily appreciated, as the same becomes better understood, after reading the subsequent description taken in conjunction with the accompanying drawings.

Disclosed herein are novel chemistries that provide unique approaches for obtaining high tensile modulus articles. Also disclosed are alternative routes for obtaining such high tensile modulus articles. For instance, the traditionally accepted methodology for coating materials comprises spraying chemicals directly onto scrim or textiles, requiring involved and complex techniques. As taught herein, the inventors have designed a unique approach utilizing the application of spray polyurethane systems comprising one, two or more applications of the spray: in one embodiment for example two spray polyurethane systems are used to form a multi-layer article: one system comprises a high tensile modulus, sprayed in a relatively thinly layer to maintain low flexural modulus (acting like a scrim/textile); the other system comprising a relatively thicker layer of spray having low tensile modulus to deliver the remainder of the bulk properties (tensile, tear strength, elongation, wear/abrasion, etc.). The complexity of the system is diminished by the ability to automate the process. In certain embodiments, articles having multilayer structures and layers can be constructed by a multiple-pass processes in three-dimension, layer-by-layer approaches comprising one or more polyurethane system systems.

### BRIEF DESCRIPTION OF FIGURES

FIG. 1 provides a graph showing a full dataset view comparing the performance of cast samples (with no aeration) against sprayed samples with reduced density as a result of aeration.

FIG. 2 provides a graph showing a magnified view of the low strain region for Samples A, B, and C (all examples of ester chemistries described herein).

### DETAILED DESCRIPTION

The present invention may be understood more readily by reference to the following detailed description of the specific embodiments included herein. Although the invention has been described with reference to specific details of certain embodiments thereof, it is not intended that such details should be regarded as limitations upon the scope of the invention. The entire text of the references mentioned herein are hereby incorporated in their entireties by reference.

Disclosed herein are novel compositions related to spray polyether and polyester polyurethane elastomeric articles and associated methods of producing such elastomer articles. More specifically, provided herein are spray polyester polyurethane elastomer articles that exhibit excellent tensile and tear strength, superior elongation performance and improved abrasion resistance performance, with tunable tensile modulus as desired. Compared to spray polyether polyurethane and spray polyurea, spray polyester polyurethane produced in accordance with the present invention provides advantages including superior mechanical properties and unique properties for new applications where spray polyether polyurethane and spray polyurea have shown limitations. For instance, articles made the processes herein comprise improved elongation performance; high resistance to organic solvents, chemical, grease, oil, and fuel; improved creep resistance, as well as excellent anti-scratch resistance. Moreover, spray polyester polyurethane elastomers produced in accordance with the present invention show better adhesion to a variety of different surfaces (fabric, plastic, wood, glass and metal) than traditional spray polyethers.

The unique properties of spray polyester elastomers produced in accordance with the present invention enable to the elastomers to be suitable for multiple uses and applications including, but not limited to, use as a protective coating, an anti-abrasion layer, an anti-slip layer, shoe components such as outsole layer, or protective coating layers to midsole and shoe upper or protective layer for apparel. The polyurethane elastomer materials described herein may also find many applications beyond those mentioned above where spray polyurethane elastomer may be utilized and for example wherein a softer thin layer with superior elongation performance is desirable.

In an embodiment, the spray polyurethane elastomer articles of the present invention are made by reacting resin blends and polyisocyanate pre-polymers (isocyanate prepolymers). The resin blends contain polyols and additives that are selectively formulated based on processing requirements and spray machine capabilities. Spray polyether polyurethane resin usually has a viscosity of 1100-1200 cps at 25° C., 400-450 cps at 45° C. and the polyether-based ISO-prepolymer has viscosity 1000-1100 at 25° C., 150-200 cps at 45° C. The spray polyester polyurethane resins in accordance with the present invention have a viscosity of approximately 2500-6800 cps at 25° C. depending upon what kind of polyester is used. All viscosities in the tables below refer to viscosities as measured at different temperatures in accordance with the method of ASTM standard D2196.

Reactivity profiles and cure profiles are important considerations for the design of desirable spray polyurethane systems and can be specifically engineered using an appropriate catalyst package. In some embodiments, the catalyst package for the present disclosure includes metal catalysts. In some embodiments, the catalyst package for the present disclosure does not include metal catalysts.

The reaction mixture comprising the spray polyurethane elastomer compositions described herein may be used in a variety of different ways: for example, the mixture may be sprayed on molds or on substrates to create a thin coating with single spray pass, or to create a thicker coating on articles through multiple spray passes. Such multiple passes can be engineered as a continuous process or a discontinuous one with preferred interval or cycle times. In certain embodiments, through a discontinuous process, each layer can be designed to have varying tensile modulus, stiffness, hardness, thickness, or tensile modulus, which can offer ample functionalities to design properties and configurations as desired. The reaction mixture can also be sprayed on fabrics, glass fiber mats or carbon fiber mats to produce reinforced composite materials for applications, for instance, apparel, footwear, and automotive purposes. The resulting articles can be soft-touch or rigid elastomers as designed. Multiple spray passes may comprise multiple systems (or multiple reaction mixtures).

Most molds used for polyurethane spray functionality are metallic with high thermal conductivity (e.g. steel, aluminum). The molds must be kept at elevated temperatures during spray operations, typically about 120° F. to 150° F., to aid the reaction of the polyurethane and obtain the necessary mechanical properties. The high thermal conductivity of these molds is necessary to deliver the necessary heat to aid the reaction. A surprising and unexpected finding of the present invention however, was the ability to spray onto a mold made of low-thermal-conductivity and still obtain desirable mechanical properties. Metallic molds generally used in the prior art are costly to produce. The use of low conductivity mold surfaces, such as plastic, is desirable because of resulting lower mold costs. In the past however, use of low conductivity mold surfaces results in articles having lower mechanical properties. The reaction mixtures of the present invention however, are suitable for use with molds having lower conductivity, without compromising the mechanical properties of the resulting articles.

In certain embodiments, the spray elastomer in accordance with the present invention may be sprayed layer-by-layer to create 3D objects, similar as layer-by-layer 3D printing, 3D casting or 3D dispensing technology, however at a much larger scale and at a faster speed. In certain embodiments, throughput of a spray machine as contemplated herein may be in the range of about 5-100 g/s, more typically about 6-30 g/s, most typically about 8-20 g/s. The thickness of each spray layer may be in the range about 0.2-3.0 mm, more typically about 0.4-2.0 mm; most typically about 0.5-1.5 mm. The throughput of the spray machine and the thickness of the spray layer may be adjusted and customized according to the utility profile of the resulting article as would be evident to one skilled in the art.

Advances in spray technology feature air injection capability to enable creation of spray elastomer parts with a lower density. In some embodiments, instruments manufactured by Hennecke, Inc. (Bridgeville, Pa., US) can be used to inject air and produce lightweight spray elastomers. Injected air creates voids in elastomer mass structures, which may lead to density reduction to about 5%-40%. In certain embodiments, the spray polyurethane elastomers in accordance with the present invention may be sprayed in a range of density about 0.10-5.00 g/cm³ 0.60-1.10 g/cm³; more typically about 0.65-1.10 g/cm³; most typically about 0.70-0.98 g/cm³. The density of the spray polyurethane elastomers may be adjusted and customized according to the utility profile of the resulting article as would be evident to one skilled in the art.

Lightweight spray polyester elastomer (e.g. 10-30% lighter) in accordance with the present disclosure shows equal or better physical properties compared to full density spray polyether elastomers, and may bring competitive advantage of lower weight for many new applications. In certain embodiments, the lightweight spray elastomers of the present invention can weigh up to 10%, 20%, 30% or 40% less than comparable standard products. In an embodiment, the weight reduction for the spray elastomer can be achieved by physically expanding the polyurethane system with air. A further advantage of the light spray polyester elastomers described herein is a reduction in overall cost.

In certain embodiments, the spray polyester elastomers in accordance with the present invention are formulated to process superior mechanical properties and show significantly improved tensile, tear and elongation compared to polyether-based spray elastomers with similar physical characteristics, density and hardness. Prior art polyurethane elastomers may sacrifice properties when lowering the density to certain extent but the spray polyester elastomers in accordance with the present disclosure maintain superior mechanical properties to a great degree. The properties of the spray polyester elastomer according to the present disclosure exhibit equal or better physical properties compared to full density spray polyether elastomers. Moreover, the properties of the spray polyester elastomers exhibit excellent properties independent of the thermal conductivity of the mold.

A catalyst package including one or more catalysts may be specially formulated to provide the spray system herein with better flow during the spraying process and reach a tack free (surface cure) in 20-90 s, more typically in 30-60 s, most typically in 40-50 s to match target processing cycle time. The spray polyurethane may be cured in heated mold at approximately 30-120° C., more typically in 40-100° C., most typically in 60-80° C. Another advantage of the methodology discussed herein is that no post cure is needed in contrast to methods comprising the use of cast elastomers wherein at least 8-24 hours may be required for post cure at >80° C.

Spray polyester polyurethane elastomers produced in accordance with the present disclosure provide advantages of improved mechanical properties and unique properties for new applications whereas previously available spray polyether polyurethane and spray polyurea have shown limitations. Moreover, spray polyester polyurethane elastomers show better adhesion to a variety of different surfaces than spray polyether. Furthermore, spray polyurethane elastomers produced in accordance with the present disclosure can be produced at lower density of approximately at least <0.95 g/cm, optionally in the range of about 0.4-0.95 g/cm or 0.60-0.95 g/cm and exhibit better physical properties than current spray polyether elastomer products with a higher density.

The spray elastomeric polyurethane of the present disclosure comprises the reaction product of an isocyanate component and an isocyanate-reactive component. In some embodiments, the isocyanate component includes a polyisocyanate. The organic polyisocyanates used in the present disclosure can include aliphatic, cycloaliphatic and aromatic two- or poly functional isocyanates and also any desired mixtures thereof. Examples include, but not limited to, monomeric methanediphenyl diisocyanate (MMDI), such as 4,4″-methanediphenyl diiso cyanate, 2,4″-methanediphenyl diisocyanate, the mixtures of monomeric methanediphenyl diisocyanates and higher nuclear homologs of methanediphenyl diisocyanate (polymeric MDI), naphthalene diisocyanate (NDI), especially 1,5-naphthalene diisocyanate, 3,3′-dimethyl-4,4′-diisocyanato biphenyl (TODI), p-phenylene diisocyanate (PPDI), tetramethylene diisocyanate, hexamethylene diisocyanate (HDI), isophorone diisocyanate (IPDI), 2,4- or 2,6-tolylene diisocyanate (TDI) or mixtures thereof.

In some embodiments, the present disclosure can use NDI, mixtures of NDI and MDI or more preferably 4,4′-MDI. The more preferably used 4,4′-MDI may comprise from 0 to 20 wt % of 2,4′-MDI and small amounts, up to about 10 wt %, of allophanate- or uretoneimine-modified polyisocyanates. Small amounts of polyphenylene polymethylene polyisocyanate (polymer MDI) can also be used. The total amount of these high functionality polyisocyanates should not exceed 5 wt %, based on the total weight of employed isocyanate.

The polyisocyanate component is at least partly mixed in a first step with polyols and optionally crosslinking and/or chain-extending agents before the mixture is reacted at 110 to 180° C., preferably at 130 to 170° C. and more preferably 140 to 155° C. to give a prepolymer having isocyanate groups. The resulting isocyanate-terminated prepolymer according to the invention preferably has an NCO content of 2 to 20 wt %, more preferably 2 to 10 wt % and especially 4 to 8 wt %.

Preferably, the isocyanate-terminated prepolymer is prepared using not less than 50 wt %, more preferably not less than 80 wt %, even more preferably not less than 90 wt % and especially 100 wt % of polyol. The isocyanate-terminated prepolymer is further prepared using not less than 50 wt %, more preferably not less than 80 wt %, even more preferably not less than 90 wt % and especially 100 wt % of isocyanate. Remaining isocyanate and remaining polyol can then be used unchanged and/or in the form of conventional prepolymers for producing the spray polyurethane elastomer of the present disclosure. Conventional prepolymers are obtained by reacting the above-described polyisocyanate, for example at temperatures of 30 to 100° C. and preferably at approximately 80° C., with polyols and optionally crosslinking and/or chain-extending agents to give the conventional prepolymer.

The isocyanate-reactive component of the present disclosure may include one or more of a polyether polyol, a polyester polyol, and combinations thereof. In some embodiments, the present disclosure uses a polyester polyol. Polyester polyols are obtainable for example from organic dicarboxylic acids having 2 to 12 carbon atoms, preferably aliphatic dicarboxylic acids having 4 to 6 carbon atoms and polyhydric alcohols, preferably diols, having 2 to 12 carbon atoms, preferably 2 to 6 carbon atoms. Useful dicarboxylic acids include for example: succinic acid, glutaric acid, adipic acid, pimelic acid, suberic acid, azelaic acid, sebacic acid, decanedicarboxylic acid, maleic acid, fumaric acid, phthalic acid, isophthalic acid and terephthalic acid. The dicarboxylic acids can be used not only individually but also mixed with each or one another. Instead of the free dicarboxylic acids, it is also possible to use the corresponding dicarboxylic acid derivatives, for example dicarboxylic esters of alcohols having 1 to 4 carbon atoms or dicarboxylic anhydrides. Preference is given to using dicarboxylic acid mixtures comprising succinic, glutaric and adipic acids in mixing ratios of, for example, from 20 to 35:35 to 50:20 to 32 parts by weight, and especially adipic acid. Examples of di- and polyhydric alcohols, especially diols, are: ethanediol, diethylene glycol, 1,2-propanediol, 1,3-propanediol, dipropylene glycol, 2-methyl-1,3-propanediol, 1,4-butanediol, 2-methyl-1,4-butanediol, 1,5-pentanediol, 3-methyl-1,5-pentanediol, 1,6-hexanediol, 1,10-decanediol, glycerol and trimethylol propane. Preference is given to using ethanediol, diethylene glycol, 2-methyl-1,3-propanediol, 1,4-butanediol, 1,5-pentanediol and 1,6-hexanediol. The diols can be used not only individually but also mixed with each or one another. Preference is given to using a mixture of ethanediol and 1,4-butanediol. It is also possible to use polyester polyols formed from lactones, e.g., ε-caprolactone or hydroxy carboxylic acids, e.g., 2-hydroxycaproic acid.

To prepare the polyester polyols, the organic, for example aromatic and preferably aliphatic, polycarboxylic acids and/or derivatives and polyhydric alcohols can be polycondensed in the absence of catalysts or preferably in the presence of esterification catalysts, advantageously in an atmosphere of inert gas, for example nitrogen, carbon monoxide, helium or argon, in the melt at temperatures of 150 to 250° C., preferably 180 to 220° C., optionally under reduced pressure, to the desired acid number, which is preferably less than 10 and more preferably less than 2. In a preferred embodiment, the esterification mixture is polycondensed at the abovementioned temperatures to an acid number of 80 to 30, preferably 40 to 30, under atmospheric pressure and then under a pressure of less than 500 mbar, preferably 50 to 150 mbar. Useful esterification catalysts include for example iron, cadmium, cobalt, lead, zinc, antimony, magnesium, titanium and tin catalysts in the form of metals, metal oxides or metal salts. However, the polycondensation can also be carried out in the liquid phase in the presence of diluting and/or entraining agents, for example benzene, toluene, xylene or chlorobenzene in order to distill off the water of condensation azeotropically. To prepare the polyester polyols, the organic polycarboxylic acids and/or derivatives and polyhydric alcohols are advantageously polycondensed in a molar ratio of from 1:1 to 1.8 and preferably from 1:1.05 to 1.2.

The polyester polyols obtained have a functionality of 1.9 to 4, 1.9 to 3, 1.9 to 2.6 or 1.9 to 2.3, and a number-average molecular weight of 480 to 4000, preferably 500 to 3200 g/mol and more preferably of 700 to 2600 g/mol. More particularly, the polyesterols used are exclusively obtained by condensation of diacids and diols.

In some embodiments, the present disclosure comprises the use of polyether polyols. Polyether polyols can be obtained by known processes, for example via anionic polymerization with alkali metal hydroxides or alkali metal alkoxides as catalysts and in the presence of at least one starter molecule comprising 2 to 3 reactive hydrogen atoms in bonded form, or via cationic polymerization with Lewis acids, such as antimony pentachloride or boron fluoride etherate formed from one or more alkylene oxides having 2 to 4 carbon atoms in the alkylene moiety. Suitable alkylene oxides are for example 1,3-propylene oxide, 1,2-butylene oxide, 2,3-butylene oxide and preferably ethylene oxide and 1,2-propylene oxide. Monomeric tetrahydrofuran can also be used. Useful catalysts further include multimetal cyanide compounds, so-called DMC catalysts. The alkylene oxides can be used singly, alternatingly in succession or as mixtures. Preference is given to using pure 1,2-propylene oxide or mixtures of 1,2-propylene oxide and ethylene oxide, wherein the ethylene oxide is used in amounts of above 0 to 50% as ethylene oxide end block (“EO-cap”), so the resulting polyols have primary OH end groups to an extent above 70%. Possible starter molecules are preferably 2 and 3-hydric alcohols, such as ethylene glycol, 1,2-propanediol, 1,3-propanediol, diethylene glycol, dipropylene glycol, 1,4-butanediol, glycerol or trimethylolpropane. The polyether polyols, preferably polyoxypropylene polyols or polyoxypropylene-polyoxy-ethylene polyols, preferably have an average functionality of 1.7 to 3 and number-average molecular weights of 1000 to 12,000, preferably of 1200 to 8000 g/mol, especially from 1500 to 6000 g/mol and even more preferably in the range from 2000 to 6000 g/mol.

Useful polyols further include polymer-modified polyols, preferably polymer-modified polyester polyols or polyether polyols, more preferably graft polyether polyols or graft polyester polyols. What is concerned here is a so-called polymer polyol, Which typically contains polymers, preferably thermoplastic polymers, at 5 to 60 wt %, preferably 10 to 55 wt %, more preferably 30 to 55 wt % and especially 40 to 50 wt %. These polymer polyester polyols are described for example in WO 05/098763 and EP-A-250 351 and are typically obtained by free-radical polymerization of suitable olefinic monomers, for example styrene, acrylonitrile, (meth)acrylates, (meth)acrylic acid and/or acrylamide, in a polyester polyol as grafting base. The side chains are generally formed as a result of free radicals transferring from growing polymer chains to polyester polyols or polyether polyols. The polymer polyol in addition to the graft copolymer comprises, predominantly, the homopolymers of the olefins, dispersed in unmodified polyester polyol or, respectively, polyether polyol. A preferred embodiment uses acrylonitrile, styrene, preferably acrylonitrile and styrene, as monomers. The monomers are optionally polymerized in the presence of further monomers, of a macromer, i.e., an unsaturated, free radically polymerizable polyol, of a moderator, and using a free-radical initiator, usually azo or peroxide compounds, in a polyester polyol or polyether polyol as continuous phase. This method is described for example in DE 111 394, U.S. Pat. Nos. 3,304,273, 3,383,351, 3,523,093, DE 1 152 536 and DE 1 152 537. During the free-radical polymerization, the macromers become co-incorporated in the copolymer chain. This results in the formation of block copolymers having a poly ester or, respectively, polyether block and a polyacrylonitrile-styrene) block, Which act as compatibilizers at the interface between the continuous phase and the disperse phase and suppress the agglomeration of the polymer polyester polyol particles. The proportion of macromers is typically in the range from 1 to 20 wt %, based on the total weight of the monomer used for preparing the polymer polyol.

A polymer polyol is preferably used, if present, together with further polyols, for example polyether polyols, polyester polyols or mixtures comprising polyether polyols and polyester polyols. These polymer polyols may be present for example in an amount of 7 to 90 wt % or of 11 to 80 wt %, all based on the total weight of component. The proportion of polymer polyol may, in some embodiments, be less than 20 wt %, based on the total weight of component, and instill other embodiments no polymer polyol is used.

The mixtures of the present invention comprising polyester polyols may comprise polyols. The proportion of polyols which is attributable in this case to polyester polyols is approximately not less than 30 wt %, not less than 70 wt % and, more particularly, it is polyester polyol which is exclusively used as higher molecular weight compound, in which case a polymer polyol based on polyester polyol is treated like a polyester polyol.

In certain embodiments, isocyanate-reactive component may also include a chain extender. Useful active hydrogen-containing chain extension agents generally contain at least two active hydrogen groups, for example, diols, dithiols, diamines, or compounds having a mixture of hydroxyl, thiol, and amine groups, such as alkanolamines, aminoalkyl mercaptans, and hydroxyalkyl mercaptans, among others. The molecular weight of the chain extenders preferably range from about 60 to about 400. A chain extender, which is a structural unit constituting the polyurethane-based resin, is preferably at least one or more selected from low molecular weight diols and low molecular weight diamines. The chain extender may be a substance having both a hydroxyl group and an amino group in the molecule, such as ethanolamine, propanolamine, butanolamine, and combinations thereof.

Non-limiting examples of suitable diols that may be used as extenders include ethylene glycol and higher oligomers of ethylene glycol including diethylene glycol, triethylene glycol and tetraethylene glycol; propylene glycol and higher oligomers of propylene glycol including dipropylene glycol, tripropylene glycol and tetrapropylene glycol; cyclohexanedimethanol, 1,6-hexanediol, 2-ethyl-1,6-hexanediol, 1,4-butanediol, 2,3-butanediol, 1,5-pentanediol, 1,3-propanediol, butylene glycol, neopentyl glycol, dihydroxyalkylated aromatic compounds such as the bis(2-hydroxyethyl) ethers of hydroquinone and resorcinol; p-xylene-α, α′-diol; the bis(2-hydroxyethyl) ether of p-xylene-α, α′-diol; m-xylene-α, α′-diol and combinations thereof. In a specific embodiment, the chain extender is 1,4-butanediol (BDO).

Non-limiting examples of organic compounds containing at least two aromatic amine groups can be used as aromatic diamine chain extenders having a molecular weight of from 100 to 1,000. The amine chain extenders can contain exclusively aromatically bound primary or secondary (preferably primary) amino groups, and preferably also contain substituents. Examples of such diamines include 1,4-diaminobenzene; 2,4- and/or 2,6-diaminotoluene; 2,4′- and/or 4,4′-diaminodiphenylmethane; 3,3′-dimethyl-4,4′-diaminodiphenylmethane; 3,3′-dichloro-4,4′-diaminodiphenylmethane (MOCA); 3,5-dimethylthiotoluene-2,4- and/or -2,6-diamine; 1,3,5-triethyl-2,4-diaminobenzene; 1,3,5-triisopropyl-2,4-diaminobenzene; 1-methyl-3,5-diethyl-2,4- and/or -2,6-diaminobenzene (also known as 3,5-diethyltoluene-2,4- and/or -2,6-diamine, or DETDA); 4,6-dimethyl-2-ethyl-1,3-diaminobenzene; 3,5,3′,5′-tetraethyl-4,4-diaminodiphenylmethane; 3,5,3′,5′-tetraisopropyl-4,4′-diaminodiphenylmethane; 3,5-diethyl-3′,5′-diisopropyl-4,4′-diaminodiphenylmethane; 2,4,6-triethyl-m-phenylenediamine (TEMPDA); 3,5-diisopropyl-2,4-diaminotoluene; 3,5-di-sec-butyl-2,6-diaminotoluene; 3-ethyl-5-isopropyl-2,4-diaminotoluene; 4,6-diisopropyl-m-phenylenediamine; 4,6-di-tert-butyl-m-phenylenediamine; 4,6-diethyl-m-phenylenediamine; 3-isopropyl-2,6-diaminotoluene; 5-isopropyl-2,4-diaminotoluene; 4-isopropyl-6-methyl-m-phenylenediamine; 4-isopropyl-6-tert-butyl-m-phenylenediamine; 4-ethyl-6-isopropyl-m-phenylenediamine; 4-methyl-6-tert-butyl-m-phenylenediamine; 4,6-di-sec-butyl-m-phenylenediamine; 4-ethyl-6-tertbutyl-m-phenylenediamine; 4-ethyl-6-sec-butyl-m-phenylenediamine; 4-ethyl-6-isobutyl-m-phenylenediamine; 4-isopropyl-6-isobutyl-m-phenylenediamine; 4-isopropyl-6-sec-butyl-m-phenylenediamine; 4-tert-butyl-6-isobutyl-m-phenylenediamine; 4-cyclopentyl-6-ethyl-m-phenylenediamine; 4-cyclohexyl-6-isopropyl-m-phenylenediamine; 4,6-dicyclopentyl-m-phenylenediamine; 2,2′,6,6′-tetraethyl-4,4′-methylenebisaniline; 2,2′,6,6′-tetraisopropyl-4,4′-methylenebisaniline(methylenebis diisopropylaniline); 2,2′,6,6′-tetra-sec-butyl-4,4′-methylenebisaniline; 2,2′-dimethyl-6,6′-di-tert-butyl-4,4′-methylenebisaniline; 2,2′-di-tert-butyl-4,4′-methylenebisaniline; and 2-isopropyl-2′,6′-diethyl-4,4′-methylenebisaniline. Such diamines may also be used as mixtures.

The isocyanate component and the isocyanate-reactive component are typically reacted at an isocyanate index of greater than or equal to a range of approximately 85 to 110). The terminology isocyanate index is defined as the ratio of NCO groups in the isocyanate component to isocyanate-reactive groups in the isocyanate-reactive component multiplied by 100. The polyurethane elastomer of the present disclosure may be produced by mixing the isocyanate component and the isocyanate-reactive component to form a mixture at room temperature or at slightly elevated temperatures, e.g. 25 to 45° C. In certain embodiments in which the elastomeric polyurethane elastomer is produced in a mold, it is to be appreciated that the isocyanate component and the isocyanate-reactive component may be mixed to form the mixture prior to disposing the mixture in the mold. For example, the mixture may be poured into an open mold or the mixture may be injected into a closed mold.

In certain embodiments, water scavengers may also be used for the production of spray polyurethane elastomers according to the present disclosure. Though not wishing to be bound by the following theory, it is thought that water scavengers may help eliminate microcellular structures that cause negative impacts on the properties of resulting articles. Water scavengers may help absorb water residue and eliminate the formation of microcellular structures that compromise the mechanical properties of the resulting spray elastomer article. We discuss non-microcellular structure elastomers (air-bubbles create small voids in elastomer mass, the voids are not connecting to each other) and the applications in the invention. This is classified to some formulations with no water, (or chemical blowing agent). In this case, the elastomeric polymers made contain mainly the urethane linkages (—NH—C(═O)—O—). The content in the section 0044-0046 needs more explanation for clarity regarding non-microcellular structures and microcellular structures, furthermore the linkages in polymers resulted from different classifications of formulations claimed in the invention. To discuss lower-density elastomeric materials with blowing agents, we may need 2^{nd} concept for “a controllable, small quantity of physical blowing agents in the formulations, the physical blowing agents create voids in elastomeric mass structures. This is another novel approach for weight reduction that also results in elastomeric polymers at lower densities. This approach can be aligned well with spray technology and other technologies for elastomeric materials making. The loading level of physical blowing agents can be customized depending upon the targeted densities, which may result in non-microcellular structures or microcellular structures, such elastomeric polymers mainly consist of urethane linkages in the polymer backbones. The 3^{rd} concept would fall into another regime that relates to chemical blowing agent, or water (in this case, no Water Scavenger used) for lower-density elastomeric materials, the reaction elastomeric polymers contain both urethane linkages and urea linkages (—NH—CO—NH—). The level of water in the formulations is determined by the densities targeted and the properties needed for various applications. The resulted elastomeric polymers can be non-microcellular structures or microcellular structures with various ratios of urethane linkages and urea linkages in the polymer structure. This is not limited to the formulations with amine terminated polyols or chain extenders, from which the polymers made contain urethane linkages and urea linkages.

Fillers can also be used to reduce the density of the sprayed article. Examples of such fillers are hollow glass bubbles (from 3M) and expandable microspheres such as Expancel (from AkzoNobel).

A catalyst component may also be used to produce the polyurethane elastomers in the current disclosure. Exemplary catalysts include, but are not limited to, N,N-dimethylethanolamine (DMEA), N,N-dimethylcyclohexylamine (DMCHA), bis(N,N-dimethylaminoethyl)ether (BDMAFE), N,N,N′,N′,N″-pentamethyldiethylenetriamine (PDMAFE), 1,4-diazadicyclo[2,2,2]octane (DABCO), 2-(2-dimethylaminoethoxy)-ethanol (DMAFE), 2-((2-dimethylaminoethoxy)-ethyl methyl-amino)ethanol, 1-(bis(3-dimethylamino)-propyl)amino-2-propanol, N,N′,N″-tris(3-dimethylamino-propyl)hexahydrotriazine, dimorpholinodiethylether (DMDEE), N.N-dimethylbenzylamine, N,N,N′,N″,N″-pentaamethyldipropylenetriamine, N,N′-diethylpiperaztne, and etc. In particular, sterically hindered primary, secondary or tertiary amines can be used, including, but are not limited to, dicyclohexylmethylamine, ethyldiisopropylamine, dimethylcyclohexylamine, dimethylisopropylamine, methylisopropylbenzylamine, methylcyclopentylbenzylamine, isopropyl-sec-butyl-trifluoroethylamine, diethyl-(o-phenyethyl) amine, tri-n-propylamine, dicyclohexylamine, t-butylisopropylamine, di-t-butylamine, cyclohexyl-t-butylamine, de-sec-butylamine, dicyclopentylamine, di-(a-trifluoromethylethyl) amine, di-(α-phenylethyl) amine, triphenylmethylamine, and 1,1,-diethyl-n-propylamine. Other sterically hindered amines are morpholines, imidazoles, ether containing compounds such as dimorpholinodiethylether, N-ethylmorpholine, N-methylmorpholine, bis(dimethyl-aminoefhyl)ether, imidizole, n-methylimidazole, 1,2-dimethylimidazole. Dimorpholinodi-methylether, N,N,N′,N′,N″,N″-pentamethyldiethylenetriamine, N,N,N′,N′,N″,N″-pentamethyl-dipropylenetriamine, bis(diethylaminoethyl)ether, bis(dimethylaminopropyl)ether, or combinations thereof. Non-amine catalysts include, but are not limited to, stannous octoate, dibutyltin dilaurate, dibutyltin mercaptide, phenylmercuric propionate, lead octoate, potassium acetate/octoate, quaternary ammonium formates, ferric acetylacetonate and mixtures thereof. The use level of the catalysts can be in an amount of about 0.05 to about 4.00 wt % of isocyanate-reactive component, from about 0.15 to about 3.60 wt %, or from about 0.40 to about 2.60 wt %. In a specific embodiment, the catalyst component can be present in the isocyanate-reactive component to catalyze the polyurethane elastomer reaction between the isocyanate component and the isocyanate-reactive component. It is to be appreciated that the catalyst component is typically not consumed to form the reaction product of the isocyanate component and the isocyanate-reactive component, but may contain active hydrogen groups that can react with the isocyanate groups. That is, the catalyst component typically participates in, but is not consumed by, the polyurethane elastomer formation reaction. The catalyst component may include any suitable catalyst or mixtures of catalysts known in the art. A suitable catalyst component for purposes of the present disclosure is Dabco® EG and Dabco® 1027, commercially available from Evonik Industries of Parsippany, N.J.

An optional additive component may comprise a surfactant, which can be used to control the structure of the polyurethane elastomer, impact the surface structure of the polyurethane elastomer and to improve miscibility of components in the isocyanate-reactive component and the resultant polyurethane elastomer stability. Suitable surfactants include any surfactant known in the art, such as silicones and nonylphenol ethoxylates. In one embodiment, the surfactant can be a polysilicone polymer. In a specific embodiment, the polysilicone polymer is a polydimethylsiloxane-polyoxyalkylene block copolymer. The surfactant can be selected according to the requirements of the isocyanate reactive component, if present in the isocyanate-reactive component. When utilized, the surfactant can be present in the isocyanate-reactive component in an amount of from about 0.5 to about 6 parts by weight based on 100 parts by weight of total polyol present in the isocyanate-reactive component.

In certain embodiments, the isocyanate component and the isocyanate-reactive component may be reacted in the presence of a blowing agent to produce the polyurethane elastomer described herein. As is known in the art, during the polyurethane elastomer formation reaction between the isocyanate component and the isocyanate-reactive component, the blowing agent promotes the release of a gas which forms cellular voids in the polyurethane elastomer. The blowing agent may be a physical blowing agent, a chemical blowing agent, or a combination of a physical blowing agent and chemical blowing agent thereof.

The terminology physical blowing agent refers to blowing agents that do not chemically react with the isocyanate component and/or the isocyanate-reactive component to provide the blowing gas. The physical blowing agent can be a gas or liquid. The liquid physical blowing agent typically evaporates into a gas when heated, and evaporates from the resulting polyurethane elastomer. Suitable physical blowing agents for the purposes of the subject disclosure may include liquid carbon dioxide (CO₂), HCFC, HFO's, pentane and all of its isomers, acetone, entrained air, other inert gases, or combinations thereof. The most typical physical blowing agents typically have a zero ozone depletion potential like but not limited to. trans-1-chloro-3,3,3-trifluoropropylene (HCFO-1233zd(E)).

The terminology chemical blowing agent refers to blowing agents which chemically react with the isocyanate component or with other components to release a gas. Examples of chemical blowing agents that are suitable for the purposes of the subject disclosure include formic acid, methyl formate, water, and combinations thereof. The blowing agent is typically present in the isocyanate-reactive component in an amount of from about 0.5 to about 20 parts by weight based on 100 parts by weight of total polyol present in the isocyanate-reactive component.

It must be appreciated that the physical and chemical blowing agents can also be used in combination. Such combinations can include, but are not limited to, water and entrained air.

The samples can be tested for tear strength in accordance with ISO 34-1. Tear strength is the measure of the force required to continue a tear in the elastomer after a split or break has been started, and is expressed in kg/cm.

The samples can be tested for tensile strength, tensile modulus, and break elongation average in accordance with DIN 53504. Tensile strength at break is the ratio of the force at break to the initial cross-sectional area of the test piece of the elastomer, and is expressed in MPa. Tensile stress at yield is the ratio of the maximum measured force to the initial cross-sectional area of the test piece, and is expressed in MPa. Tensile modulus is the ratio of stress (force per unit area) along an axis to strain (ratio of deformation over initial length) along that axis, and is expressed in MPa. The elongation at break is the ratio of the change in length at break to the initial gauge length of the test piece, and is expressed in %.

The samples can be tested for density in accordance with ISO 1183. Density is the mass per volume of a test piece of the elastomer, and is expressed in g/cm³.

The apparent viscosity of the polyols in the present disclosure can be tested in accordance with ASTM D2196. Apparent viscosity is the shear stress applied to a fluid divided by the shear rate, and is expressed in cps.

Reference will now be made to specific examples illustrating the disclosure. It is to be understood that the examples are provided to illustrate exemplary embodiments and that no limitation to the scope of the disclosure is intended thereby.

The invention will be further described with reference to the following examples; however, it is to be understood that the invention is not limited to such examples. Rather, in view of the present disclosure that describes the current best mode for practicing the invention, many modifications and variations would present themselves to those of skill in the art without departing from the scope and spirit of this invention. All changes, modifications, and variations coming within the meaning and range of equivalency of the claims are to be considered within their scope.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present disclosure may be practiced other than as specifically described.

### EXAMPLES

Polyol 1 is adipate Acid-ethylene glycol-1,4-butanediol-initiated polyester polyol, having an average hydroxyl number of 56.

Polyol 2 is adipate Acid-ethylene glycol-1,4-butanediol-initiated polyester polyol, the structure is different from polyol 1, also having an average hydroxyl number of 56.

Polyol 3 is adipate Acid-ethylene glycol-1,4-butanediol-initiated polyester polyol, having an average hydroxyl number of 80.

Polyol 4 is a graft polyester polyol, having an average hydroxyl number of 60.

Polyol 5 is a glycerine-initiated polyether polyol, including propylene oxide and ethylene oxide having a hydroxyl number 35.

Polyol 6 is a dipropylene glycol initiated polyether polyol having a hydroxyl number of 29.

Polyol 7 is a graft polyol having 32% solids (1:2 acrylonitrile:styrene), having a hydroxyl number of 24.

Polyol 8 is a polytetrahydrofuran polyether polyol, having a hydroxyl number of 110.

Polyol 9 is a polytetrahydrofuran polyether polyol, having a hydroxyl number of 56.

Chain extender 1 is 1,4-butanediol; chain extender 2 is ethylene glycol.

Catalyst 1 is triethylenediamine diluted in ethylene glycol, for instance, DABCO EG; Catalyst 2 is delayed action tertiary amine diluted in ethylene glycol, for instance, DABCO 1027; Catalyst 3 is tin catalyst, for instance, Fomrez UL-22; Catalyst 4 is a bismuth neodecanoatefzinc neodecanoate catalyst, for instance, Bicat; Catalyst 5 is triethylenediamine diluted in 1,4-butanediol catalyst, for instance, DABCO S25; Catalyst 6 is delayed action tertiary amine diluted in 1,4-butanediol, for instance, DABCO 1028. (Catalyst 7 is triethylenediamine dissolved in dipropylene glycol, for instance, Dabco® 33-LV; Catalyst 8 is a delayed action tertiary amine based on DBU, for instance, Polycat SA-102.)

Additive 1 is Defoamer, for instance, Anti-foam A; Additive 2 is Water Scavenger, for instance, Molecular Sieve 3A, or mixtures contain Molecular Sieve 3A; Additive 3 is fumed silica, for instance, Areosil R 972; Additive 4 is Colorants, for instance, Grey Repitan; Additive 5 is light stabilizer, for instance, TINUVIN 123 HALS and TINUVIN 123 HALS.

Isocyanate Prepolymer 1 is Elastopan® 41640T Isocyanate; Isocyanate Prepolymer 2 is Lupranate® MP102 (both commercially available from BASF Corporation of Florham Park, N.J.).

TABLE 1
Polyols Combination - Examples and properties

| Elastomer Ingredient (%) | Example 1 | Example 2 | Example 3 | Example 4 | Example 5 | Example 6 | Example 7 | Example 8 | Example 9 |
|---|---|---|---|---|---|---|---|---|---|
| Polyol 1 | 39.96 | — | 19.98 | 29.98 | — | — | — | — | — |
| polyol 2 | — | 39.96 | 19.98 | 9.99 | 19.60 | 9.70 | | | |
| Polyol 3 | — | — | — | — | 19.60 | 29.12 | 29.08 | 19.54 | 0.00 |
| Polyol 4 | — | — | — | — | — | — | 9.69 | 19.54 | 39.71 |
| Chain Extender 1 | 5.60 | 5.60 | 5.60 | 5.60 | 5.49 | 5.44 | 5.43 | 5.47 | 5.56 |
| Catalyst 1 | 0.47 | 0.47 | 0.47 | 0.47 | 0.46 | 0.45 | 0.45 | 0.46 | 0.46 |
| Catalyst 2 | 0.14 | 0.14 | 0.14 | 0.14 | 0.14 | 0.14 | 0.14 | 0.14 | 0.14 |
| Additive 1 | 0.14 | 0.14 | 0.14 | 0.14 | 0.14 | 0.14 | 0.14 | 0.14 | 0.14 |
| Additive 2 | 0.23 | 0.23 | 0.23 | 0.23 | 0.23 | 0.23 | 0.23 | 0.23 | 0.23 |
| Additive 3 | 0.09 | 0.09 | 0.09 | 0.09 | 0.09 | 0.09 | 0.09 | 0.09 | 0.09 |
| Resin | 46.63 | 46.63 | 46.63 | 46.63 | 45.74 | 45.30 | 45.23 | 45.59 | 46.33 |
| Isocyanate Prepolymer 1 | 53.37 | 53.37 | 53.37 | 53.37 | 54.26 | 54.70 | 54.77 | 54.41 | 53.67 |
| Total Weight | 100.00 | 100.00 | 100.00 | 100.00 | 100.00 | 100.00 | 100.00 | 100.00 | 100.00 |
| Split Tear Average | 61.01 | 60.71 | 57.98 | 62.96 | 57.95 | 58.45 | 49.48 | 41.61 | 39.32 |
| (kg/cm, ISO 34-1) | | | | | | | | | |
| Tensile-Peak | 40.28 | 40.94 | 37.12 | 37.91 | 41.88 | 44.27 | 44.27 | 43.48 | 33.50 |
| Stress Average | | | | | | | | | |
| (MPa, DIN 53504 S2) | | | | | | | | | |
| Break Elongation | 626.48 | 661.20 | 617.67 | 609.77 | 665.37 | 627.40 | 619.85 | 592.13 | 491.45 |
| Average (%, DIN | | | | | | | | | |
| 53504 S2) | | | | | | | | | |
| Tension - Elastic | 54.48 | 54.48 | 58.48 | 60.70 | 56.85 | 57.81 | 70.67 | 87.31 | 134.80 |
| Modulus Average | | | | | | | | | |
| (Mpa, DIN 53504 S2) | | | | | | | | | |

Notes:
Density (g/cm3): 1.01 ± 0.01, ISO 1183;
Thickness (mm): 1.1 ± 0.1

TABLE 2
Chain Extender-Examples and properties

| Elastomer | Example | Example | Example | Example | Example |
|---|---|---|---|---|---|
| Ingredient (%) | 10 | 11 | 12 | 13 | 14 |
| Polyol 3 | 62.71 | 59.42 | 56.45 | 53.77 | 51.33 |
| Chain Extender 1 | 1.32 | 1.88 | 2.38 | 2.84 | 3.25 |
| Catalyst 1 | 0.66 | 0.63 | 0.60 | 0.57 | 0.54 |
| Catalyst 2 | 0.20 | 0.19 | 0.18 | 0.17 | 0.16 |
| Additive 1 | 0.20 | 0.19 | 0.18 | 0.17 | 0.16 |
| Additive 2 | 0.33 | 0.31 | 0.30 | 0.28 | 0.27 |
| Additive 3 | 0.13 | 0.13 | 0.12 | 0.11 | 0.11 |
| Total Resin | 65.56 | 62.74 | 60.21 | 57.91 | 55.83 |
| Resin | 65.56 | 62.74 | 60.21 | 57.91 | 55.83 |
| Isocyanate | 34.44 | 37.26 | 39.79 | 42.09 | 44.17 |
| Prepolymer 1 | | | | | |
| Split Tear Average | 18.87 | 29.76 | 32.47 | 41.21 | 48.90 |
| (kg/cm, ISO 34-1) | | | | | |
| Tensile-Peak Stress | 31.07 | 36.66 | 45.31 | 49.74 | 51.12 |
| Average (MPa, | | | | | |
| DIN 53504 S2) | | | | | |
| Break Elongation | 791.40 | 802.58 | 800.75 | 778.33 | 750.33 |
| Average | | | | | |
| (%, DIN 53504 S2) | | | | | |

Notes:
Density (g/cm3): 1.01 ± 0.01, ISO 1183;
Thickness (mm): 1.1 ± 0.1

TABLE 3
Chain Extenders-Combination and properties

| Elastomer Ingredient (%) | Example 15 | Example 16 | Example 17 |
|---|---|---|---|
| Polyol 3 | 49.69 | 49.97 | 50.53 |
| Chain Extender 1 | 1.57 | 1.90 | 2.56 |
| Chain Extender 2 | 2.62 | 2.11 | 1.07 |
| Catalyst 1 | 0.52 | 0.53 | 0.53 |
| Catalyst 2 | 0.16 | 0.16 | 0.16 |
| Additive 1 | 0.16 | 0.16 | 0.16 |
| Additive 2 | 0.26 | 0.26 | 0.27 |
| Additive 3 | 0.52 | 0.53 | 0.53 |
| Resin Total | 55.51 | 55.61 | 55.81 |
| Isocyanate Prepolymer 1 | 44.49 | 44.39 | 44.19 |
| Total Weight | 100.00 | 100.00 | 100.00 |
| Split Tear Average | 20.41 | 23.10 | 31.96 |
| (kg/cm, ISO 34-1) | | | |
| Tensile-Peak Stress Average | 30.84 | 32.98 | 39.38 |
| (MPa, DIN 53504 S2) | | | |
| Break Elongation Average | 632.93 | 664.05 | 691.45 |
| (%, DIN 53504 S2) | | | |
| Tension - Elastic Modulus | 7.02 | 8.97 | 13.56 |
| Average (MPa, DIN 53504 S2) | | | |

Notes:
Density (g/cm3): 1.01 ± 0.01, ISO 1183;
Thickness (mm): 1.1 ± 0.1

TABLE 4
Cross-linking Agent (Cross-linker)-Examples and Properties

| Elastomer Ingredient | Example | Example | Example | Example |
|---|---|---|---|---|
| (%) | 18 | 19 | 20 | 21 |
| Polyol 3 | 42.02 | 41.35 | 43.28 | 42.58 |
| Chain Extender 1 | 4.79 | 4.74 | 4.42 | 4.37 |
| Catalyst 1 | 0.48 | 0.47 | 0.49 | 0.49 |
| Catalyst 2 | 0.14 | 0.14 | 0.15 | 0.15 |
| Cross-linker | | 0.24 | 0.25 | 0.49 |
| Additive 1 | 0.14 | 0.14 | 0.15 | 0.15 |
| Additive 2 | 0.24 | 0.24 | 0.25 | 0.24 |
| Additive 3 | 0.10 | 0.09 | 0.10 | 0.10 |
| Resin Total | 47.91 | 47.42 | 49.06 | 48.56 |
| Isocyanate Prepolymer 1 | 52.09 | 52.58 | 50.94 | 51.44 |
| Total | 100.00 | 100.00 | 100.00 | 100.00 |
| Split Tear Average | 49.80 | 50.80 | 45.17 | 39.30 |
| (kg/cm) | | | | |
| Tensile-Peak Stress | 47.47 | 40.10 | 44.49 | 43.71 |
| Average (MPa) | | | | |
| Break Elongation Average | 683.63 | 578.28 | 603.00 | 602.95 |
| (%) | | | | |
| Tension - Elastic Modulus | 43.36 | 40.43 | 38.12 | 34.74 |
| Average (Mpa) | | | | |

Notes:
Density (g/cm3): 1.01 ± 0.01, ISO 1183
Thickness (mm): 1.1 ± 0.1

TABLE 4
Physical properties of spray polyether polyurethane at lower density.

| Elastomer Ingredient (%) | Example 22 | Example 23 | Example 24 |
|---|---|---|---|
| Polyol 5 | 33.01 | 32.80 | 32.48 |
| Polyol 6 | 20.30 | 20.17 | 19.98 |
| Polyol 7 | 6.77 | 6.72 | 6.66 |
| Chain extender 1 | 6.09 | 6.05 | 5.99 |
| Catalyst 7 | 0.68 | 0.67 | 0.67 |
| Catalyst 8 | 0.14 | 0.13 | 0.13 |
| Catalyst 4 | 0.02 | 0.02 | 0.02 |
| Additive 1 | 0.14 | 0.13 | 0.13 |
| Additive 2 | 0.34 | 0.34 | 0.33 |
| Additive 3 | 0.20 | 0.20 | 0.20 |
| Resin | 67.68 | 67.24 | 66.60 |
| Isocyanate Prepolymer 2 | 32.32 | 32.76 | 33.40 |
| Total weight | 100.00 | 100.00 | 100.00 |
| Properties | | | |
| Graves Tear | 23.48 | 24.64 | 23.12 |
| (kg/cm, ISO 34-1) | | | |
| Split Tear Average | 8.27 | 7.62 | 6.77 |
| (kg/cm, ISO 34-1) | | | |
| Tensile-Peak Stress | 387 | 366 | 320 |
| Average (MPa, DIN | | | |
| 53504 S2) | | | |
| Break Elongation | 5.60 | 5.46 | 5.34 |
| Average (%, DIN | | | |
| 53504 S2) | | | |

Notes:
Density (g/cm3), 0.80 ± 0.05 ISO 1183
Thickness (mm): 1.1 ± 0.1
Notes:
Density (g/cm3), 0.80 ± 0.05 ISO 1183
Thickness (mm): 1.1 ± 0.1

TABLE 5
Physical properties of spray polyester polyurethane at lower density.

| Elastomer Ingredient (%) | Example 25 | Example 26 | Example 27 | Example 28 | Example 29 |
|---|---|---|---|---|---|
| Polyol 3 | 47.46 | 47.77 | 47.45 | 47.21 | 47.46 |
| Chain Extender 1 | 5.39 | 5.42 | 5.39 | 5.36 | 5.39 |
| Catalyst 5 | 0.54 | 0.54 | 0.54 | 0.64 | 0.54 |
| Catalyst 6 | 0.16 | 0.16 | 0.16 | 0.16 | 0.16 |
| Catalyst 3 | 0.00 | 0.00 | 0.01 | 0.01 | 0.00 |
| Additive 1 | 0.16 | 0.05 | 0.16 | 0.16 | 0.16 |
| Additive 3 | 0.54 | 0.00 | 0.54 | 0.54 | 0.54 |
| Additive 2 | 0.27 | 0.27 | 0.27 | 0.27 | 0.27 |
| Total Resin Weight | 54.51 | 54.22 | 54.52 | 54.34 | 54.51 |
| Isocyanate Prepolymer 1 | 45.49 | 45.78 | 45.48 | 45.66 | 45.49 |
| Total Weight | 100.00 | 100.00 | 100.00 | 100.00 | 100.00 |
| Grave Tear Average | 34.4 | 39.48 | 39.1 | 38.13 | 52.11 |
| (kg/cm, ISO 34-1) | | | | | |
| Split Tear Average | 18.62 | 20.91 | 20.91 | 18.58 | 27.7 |
| (kg/cm, ISO 34-1) | | | | | |
| Tensile-Peak | 7.76 | 15.21 | 11.34 | 14.32 | 17.89 |
| Stress Average | | | | | |
| (MPa, DIN 53504 S2) | | | | | |
| Break Elongation | 529 | 601 | 604 | 589 | 655 |
| Average (%, DIN | | | | | |
| 53504 S2) | | | | | |

Notes:
Density (g/cm3), 0.80 ± 0.05 ISO 1183
Thickness (mm): 1.1 ± 0.1
Notes:
Density (g/cm3), 0.75 ± 0.05 ISO 1183
Thickness (mm): 1.1 ± 0.1

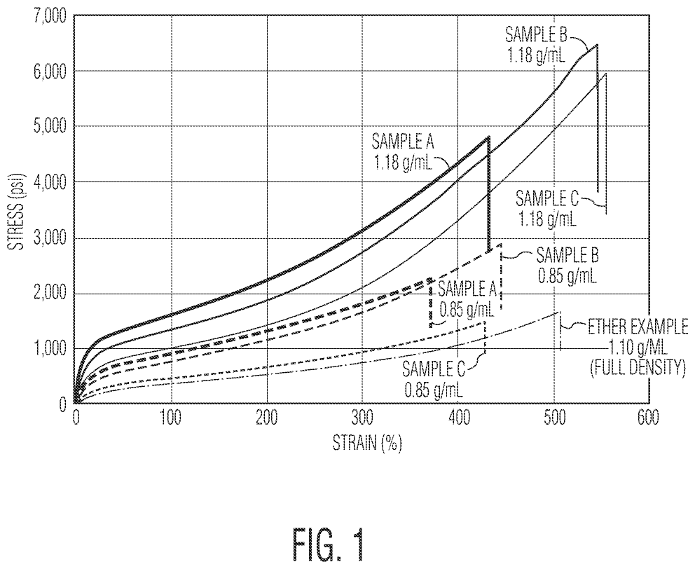

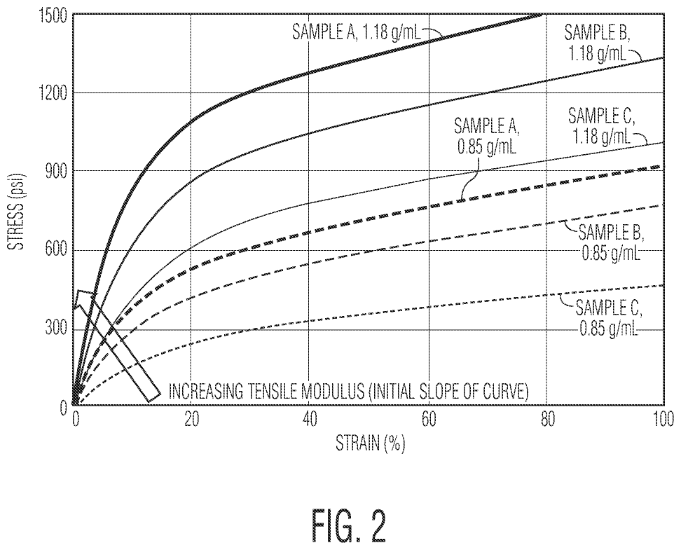

Graph 1 as shown in FIG. 1 is a full dataset view comparing the performance of cast samples (with no aeration) against sprayed samples with reduced density as a result of aeration. As density is reduced, tensile strength and modulus are also reduced along with ultimate elongation. Samples A, B, and C are all examples of the polyester chemistry describe in this patent. For comparison, a typical tensile curve for a full density polyETHER is provided. All of the ester-based examples show superior performance versus the ether example, even at low densities.
Graph 2 as shown in FIG. 2 is a magnified view of the low strain region for Samples A, B, and C (all examples of ester chemistries described herein). The chart shows that both the ester chemistry and spray density can be manipulated to deliver a desired tensile modulus.

Those skilled in the art will recognize, or be able to ascertain, using no more than routine experimentation, numerous equivalents to the specific composition and procedures described herein. Such equivalents are considered to be within the scope of this disclosure, and are covered by the following claims.

1. A spray polyurethane elastomer, comprising:
(a) an isocyanate functional urethane prepolymer derived from monomeric diphenylmethane diisocyanate (MMDI) and a polyol; and
(b) an isocyanate-reactive component comprising:
(i) a first polyol in an amount of about 60 to 98 parts by weight of the isocyanate-reactive component, wherein the first polyol is a polyol with a hydroxyl number of about 30 to about 200 mg KOH/g.

2. (canceled)

3. The spray polyurethane elastomer of claim 1, wherein the first polyol is in the amount of about 80 to 95 parts by weight of the isocyanate-reactive component.

4. The spray polyurethane elastomer of claim 1, wherein the first polyol has a weight-averaged molecular weight at about 500 to 5000 g/mol.

5. The spray polyurethane elastomer of claim 1, wherein the first polyol is an adipate acid-ethylene glycol-1,4-butanediol initiated polyester polyol.

6. The spray polyurethane elastomer of claim 1, further comprising a catalyst in an amount of about 0.05 to about 4.00 parts by weight of the isocyanate-reactive component.

7. The spray polyurethane elastomer of claim 1, further comprising a chain extender with a molecular weight from about 60 to about 400.

8. The spray polyurethane elastomer of claim 1, wherein the isocyanate-reactive component further comprising a second polyol.

9-16. (canceled)

17. A method for making an elastomer composition, comprising the steps of:
reacting an MMDI with a polyester polyol to form an isocyanate functional urethane prepolymer,
blending a polyol to form an isocyanate-reactive component;
and mixing the isocyanate prepolymer and the isocyanate-reactive component at about 100 isocyanate index to about 110 isocyanate index to form the polyurethane elastomer, wherein the first polyol in an amount of about 60 to 98 parts by weight of the isocyanate-reactive component, and the first polyol is a polyester polyol with a hydroxyl number of about 30 to about 200 mg KOH/g.

18. (canceled)

19. (canceled)

20. The method of claim 17, further comprising a step to decrease the density of the elastomer composition.

21. The method of claim 20, wherein the step to decrease the density of the elastomer composition comprises air injection, addition of a physical blowing agent, addition of a chemical blowing agent, addition of a nucleating agent, or addition of fillers.

22. (canceled)

23. A method for producing an article for consumer or industrial use wherein the article has superior functionality,
wherein the article comprises one or more outer layers comprising an elastomer composition applied by spraying,
wherein the one or more outer layers comprise the same or different elastomer compositions applied by one or more spray systems,
and wherein the elastomer composition comprises the product of reacting an MMDI with a polyester polyol to form an isocyanate functional urethane prepolymer comprising blending a polyol to form an isocyanate-reactive component; and mixing the isocyanate prepolymer and the isocyanate-reactive component at about 100 isocyanate index to about 110 isocyanate index to form the polyurethane elastomer, wherein the first polyol in an amount of about 60 to 98 parts by weight of the isocyanate-reactive component, and the first polyol is a polyester polyol with a hydroxyl number of about 30 to about 200 mg KOH/g.

24. (canceled)

25. The method of claim 23, wherein the spray systems comprise spraying layer-by-layer.

26. The method of claim 25, wherein the throughput of the spray systems comprises 5-100 g/s, 6-30 g/s, or 8-20 g/s.

27. The method of claim 23, wherein the thickness of each spray layer is in the range of about 0.1-5.0 mm, 0.2-3.0 mm, 0.4-2.0 mm or 0.5-1.5 mm.

28. A spray polyurethane elastomer, comprising:
(a) an isocyanate functional urethane prepolymer derived from monomeric diphenylmethane diisocyanate (MMDI) and a first polyol; and
(b) an isocyanate-reactive component comprising:
(i) a second polyol in an amount of about 60 to 98 parts by weight of the isocyanate-reactive component, wherein the second polyol is a polyol with a hydroxyl number of about 30 to about 200 mg KOH/g.

29. The spray polyurethane elastomer of claim 28, wherein the isocyanate functional urethane prepolymer comprises Elastopan® 41640T Isocyanate or Lupranate® MP102.

30. The spray polyurethane elastomer of claim 28, wherein the second polyol comprises adipate acid-ethylene glycol-1,4-butanediol-initiated polyester polyol, a graft polyester polyol, a glycerine-initiated polyether polyol, including propylene oxide and ethylene oxide, a dipropylene glycol initiated polyether polyol, a graft polyol having 32% solids (1:2 acrylonitrile:styrene), and a polytetrahydrofuran polyether polyol.

31. The spray polyurethane elastomer of claim 28 further comprising one or more chain extenders.

32. The spray polyurethane elastomer of claim 31, wherein the chain extender comprises molecular weight from about 60 g/mol to about 400 g/mol.

33. The spray polyurethane elastomer of claim 31, wherein the chain extender comprises 1,4-butanediol or ethylene glycol.

34. The spray polyurethane elastomer of claim 28, further comprising one or more catalysts.

35. The spray polyurethane elastomer of claim 28, further comprising a catalyst in an amount of about 0.05 to about 4.00 parts by weight of the isocyanate-reactive component.

36. The spray polyurethane elastomer of claim 34, wherein the catalyst comprises triethylenediamine diluted in ethylene glycol, DABCO® EG; delayed action tertiary amine diluted in ethylene glycol, DABCO® 1027, tin catalyst, Fomrez UL-22, bismuth neodecanoatefzinc neodecanoate catalyst, Bicat, triethylenediamine diluted in 1,4-butanediol catalyst, DABCO® S25, delayed action tertiary amine diluted in 1,4-butanediol, DABCO® 1028, triethylenediamine dissolved in dipropylene glycol, DABCO® 33-LV, a delayed action tertiary amine based on DBU, Polycat SA-102.

37. The spray polyurethane elastomer of claim 28 further comprising one or more additives.

38. The spray polyurethane elastomer of claim 37, wherein the additive comprises a defoamer, anti-foam A; water scavenger, Molecular Sieve 3A, fumed silica, Areosil R 972, colorants, light stabilizer, TINUVIN 123 HALS, or TINUVIN 123 HALS.

39. The spray polyurethane elastomer of claim 28, wherein the second polyol is in the amount of about 70 to 95 parts by weight of the isocyanate-reactive component.

40. The spray polyurethane elastomer of claim 28, wherein the second polyol is in the amount of about 80 to 95 parts by weight of the isocyanate-reactive component.

41. The spray polyurethane elastomer of claim 28, wherein the second polyol has a weight-averaged molecular weight at about 500 to 5000 g/mol.

42. The spray polyurethane elastomer of claim 28, wherein the isocyanate-reactive component further comprising a third polyol.

43. The spray polyurethane elastomer of claim 42, wherein the third polyol is a polyester polyol.

44-51. (canceled)
